(19) United States
(12) Patent Application Publication
(10) Pub. No.: US 2012/0251986 A1
(43) Pub. Date: Oct. 4, 2012

(54) Abacus-type math teaching device and method

(76) Inventor: Letha Silas-Martin, Jonesboro, GA (US)

(21) Appl. No.: 13/065,703

(22) Filed: Mar. 28, 2011

(51) Int. Cl. G09B 19/02

(52) U.S. Cl. 434/203

(57) ABSTRACT

The device disclosed in the present application is a compact and convenient mathematical manipulative that can be used to assist students who have varied modalities or learning styles (auditory, visual, tactile, vocal). The device essentially comprises two parallel, co-planar U-shaped “storage” and “operational” rods, with one prong of each U-shape connected to a support handle, and the remaining prong of each rod joined to each other via a short-segmented undulated horizontal segment. Each “operational” rod supports an even-numbered quantity of through-drilled beads which may be slidably positioned along the lengths of the storage and operational rods. The beads may be of a first color on one pair of rods and a second color on the opposite pair of rods and further, each rod is designated as either a negative (−) or (+) calculator. By manipulating the beads, a learner can readily understand concepts and operations such as whole number calculations, algebraic concepts, equations, and organizing thought processes.

### CROSS-REFERENCES TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

(1) Field of the Invention

The inventive concept disclosed herein is associated with physical, or mechanical, devices effective in the teaching and explanation of elementary, advanced, and abstract mathematical problems and concepts.

The inventive concept herein belongs to the field of learning devices entitled mathematical manipulatives. These types of devices are assemblages or apparatuses constructed so that a student can learn some mathematical concept by re-arranging, dis-assembling, positioning, or otherwise handling the device. Mathematical manipulatives are very effective in helping children learn concepts in developmentally appropriate, hands-on ways. Such devices are often used as a preliminary means of teaching elemental mathematical concepts, that of concrete representation. More advanced concepts of mathematical comprehension include the steps of representational and abstract concepts, respectively.

Mathematical manipulatives are often designed by individual teachers to correspond to the comprehensional level of a student (or students) in their classroom. These devices can also be purchased, and among the more commonly available commercial devices include Tangrams; Cuisenaire rods; Numicon patterns; Diene's blocks; interlocking cubes; base ten blocks; pattern blocks; colored chips; links; stacks; color tiles; and geoboards.

(2) Description of the Related Art, Including Information Disclosed Under 37 CFR 1.97 and 1.98

Over the past several years, there have been several devices designed for the purpose of providing a mechanical and/or tangible means of teaching math and mathematical concepts to students. The following documents, some of which exhibit a slight similarity to the instant inventive concept, are included among the prior art devices found:

U.S. Pat. No. 7,500,852 (2009), which discloses a device for instructing mathematics comprising a work surface and a plurality of movable elements. Each of the movable elements includes, on a front surface thereof, at least a portion of a visible mathematical symbol (including numeric and normumeric symbols) and further includes an attachment member on a rearward surface to attach the element to the work surface. The attachment member preferably allows the element to be removed from the work surface and to be slidably positioned to any position on the work surface once attached thereto.

The inventor in US patent application publication #2007/0020593 (2007) devised an educational tool including a frame having a rod extending between its opposite sides. A number of beads are slidably positioned on the rod. A reckoning bar is slidably secured to the top of the frame. The reckoning bar bears indicia, for counting the beads, in the form of a series of whole numbers that increase from one side of the frame to the other. Another reckoning bar is slidably secured to the bottom of the frame and bears indicia, for counting the beads, in the form of a series of whole numbers that increase in a direction opposite that provided to the indicia on the first reckoning bar.

U.S. Pat. No. 6,884,077 (2005) features an apparatus and method for teaching mathematics to children. In one embodiment, the apparatus comprises a flat, ruler-like rod having expressed on one face a vertically arranged base-ten number line; lips at the ends of the rod; spaced-apart grooves on the back face of the rod; and an attached sleeve sized to snugly accommodate the rod and to slide thereon while indicating respective numerals on the number line. A method is described for using the apparatus to teach elementary school children math concepts using a vertically oriented number line.

U.S patent application publication #2003/0148250 (2003) is a teaching aid comprising a frame 1, a plurality of elongate rods 2 mounted horizontally in the frame 1 and spaced vertically from each other, and a plurality of polyhedral blocks 3 rotatably mounted on each rod. Means are provided to releasably hold each block 3 in at least three discrete rotary positions on its respective rod 2.

In U.S. Pat. No. 6,413,099 (2002). The inventor fabricated a device consisting of arms which revolve on a handle. The device can be manipulated in a number of ways and adapts both to play and to serious educational purpose. In its broad educational mode, the device is an exploration tool and toy where children can develop skills and play invented games. In its primary educational use, the device is a mathematics exploration tool and toy. It is of a construction which makes it compatible with the decimal system. In particular, the device provides a visual-kinesthetic method of teaching math.

A device and method for demonstrating number theory is disclosed in U.S. Pat. No. 6,171,111 (2001). The device comprises a frame consisting of a plurality of spaced parallel rods which are secured at their ends to transverse members. The rods carry slidable members which are arranged to define a triangle having the same number members on each side. The rods are spaced apart and the members are sized so that sliding movement of one bead will contact a bead located in the next adjacent rod and cause it to also slide. Depending on location of selected base member being manipulated, some or all of the members in the equilateral triangle are moved simultaneously. The resulting array of members visually demonstrates the results of the mathematical principle applied to the triangle.

U.S. Pat. No. 5,725,380 (1998) discloses a portable and foldable teaching aid combining an abacus and an inclined writing surface. The abacus helps teach math skills and the inclined writing surface helps strengthen hand and wrist muscles that are used in writing. The abacus and writing board are positioned in physical proximity to one another to encourage children to write down math problems on the writing board, to solve them on the abacus, and to write down the answer on the writing board. The writing board is releasably attached to support rods so that it can be separated from them when the device is folded for storage.

U.S. Pat. No. 5,645,431 (1997) features an apparatus and method for teaching mathematical expressions comprising a plurality of four-sided members that represent the variables of factors of a mathematical expression. Each four-sided member has a different area representing a different variable in the mathematical expression. The four-sided members include a first side having a first color and a second side having a second color, different from the first color, wherein the first side represents a positive number, and the second side represents a negative number.

The inventor in U.S. Pat. No. 5,205,747 (1993) devised an educational toy useable to teach elementary mathematics to children. The toy features a spaced series of mutually aligned parallel rods secured in a side-by-side relationship at their opposite end to the base portion of the toy. Series of counting beads are captively and slidably mounted on all but two of the rods for movement between their opposite end portions. The remaining two rods slidably carry two operational sign beads having convex polygonal cross-sections. By sliding the two sign beads and appropriate groups of the counting beads onto the same end portions of their associated rods, and rotatably adjusting the sign beads, a variety of simple mathematical equations can quickly and easily be represented by the beads in a form easily understood by a child.

### BRIEF SUMMARY OF THE INVENTION

The device disclosed in the present application, which for ease of reference herein, is referred to as Oper-Ring, is a compact and convenient manipulative that can be used to assist students who have varied modalities or learning styles (auditory, visual, tactile, vocal). Tactile and visual learners will understand meanings of mathematics concepts quickly and easily, as well as retain and make connections to other concepts so that application of mathematics problem-solving is possible. The device comprises two vertically-oriented rods containing beads having a through-hole, which through-hole is of a dimension allowing the beads to be slidably positioned up and down the length of each respective rod.

The concepts that can be taught using the disclosed manipulative are those which are basic to the understanding of whole number operations (addition, subtraction, multiplication, division), algebraic concepts such as laws of signed numbers, solving equations, making connections to patterns, and organizing the thought processes of learning.

Essentially, as shown in FIG. 3, while a user holds the Oper-Ring by grasping its support handle 1 with his/her supporting hand 18, the user manipulates the beads 13, 14, with his/her operational hand 19 so as to calculate an answer. By moving the beads themselves, the tactile learner gains greater meaning of operations, clue words, operations, theories, and patterns, all of which are prerequisite to applications in algebra, geometry, and statistics. The visual learner can “see” the answer readily by observing the relationships of the beads 13, 14 after performing an operation. The vocal learner can “talk-it-out” to him/herself” while manipulating the beads, while the auditory learner can “hear” the meaning of the operation with greater understanding. These four senses used to make meaning of situations (hearing, seeing, touching, and saying) are in constant motion when using the Oper-Ring 1 in conjunction with the teaching/learning process.

### BRIEF DESCRIPTION OF THE VIEWS OF THE DRAWINGS

FIG. 1 depicts a full view of the Oper-Ring, from a perspective displaying the front face of the handle.

FIG. 2 presents a full view of the Oper-Ring, from the perspective showing the back face of the handle.

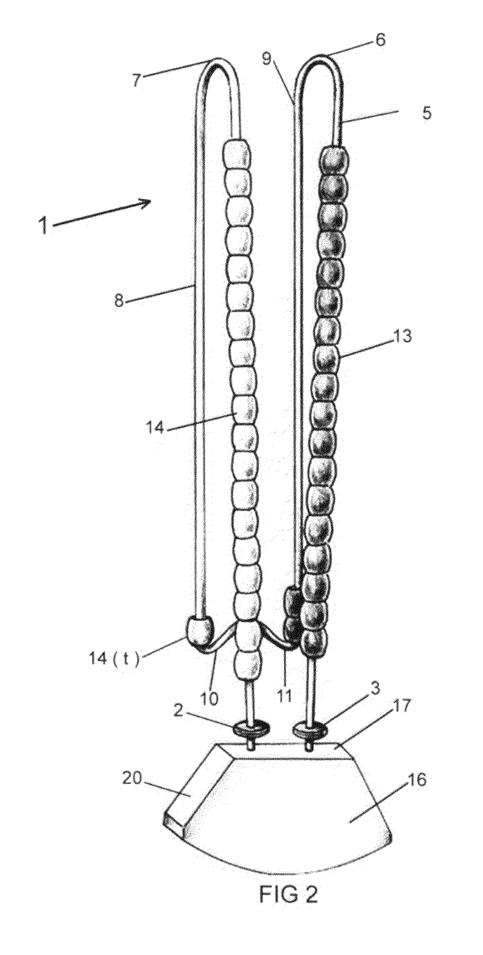

FIG. 3 displays the Oper-Ring after a user has performed a basic operational placement of beads.

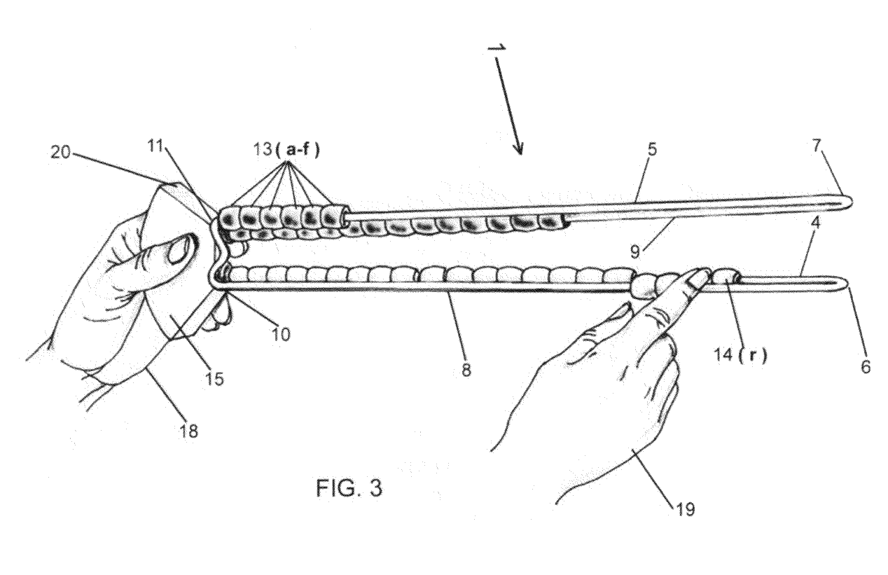

Table of Nomenclature & Part Numbers of Invention

```
  1. Oper-Ring
  2. R. (positive) support disc
  3. L. (negative) support disc
  4. R. (+) storage rod
  5. L. (−) storage rod
  6. R. (+) apex
  7. L. (−) apex
  8. R. (+) operational rod
  9. L. (−) operational rod
10. R. retaining bend
11. L. retaining bend
12. Divider bend
13. Dark beads [13(a) through 13(t)]
14. Light beads [14(a) through 14(t)]
15. Front face of support handle
16. Back face of support handle
17. Top of handle
18. User's supporting hand
19. User's operational hand
20. Support handle
```

### DETAILED DESCRIPTION OF THE INVENTION

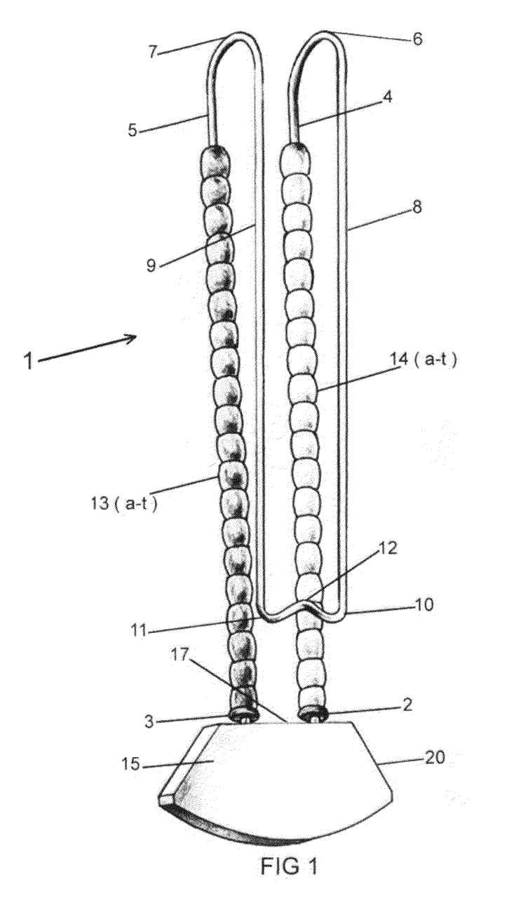

In referring to FIG. 1, there is displayed the Oper-Ring 1 at rest, or, with the device at its neutral starting position. The support handle 20, with its front face 15 shown, is the primary support for the entire device. Extending from an anchoring point in the left side of the top surface 17 of the Oper-Ring 1 device is seen to be one continuous rod, which is bent and formed into several segments. All segments of the rod, hereinafter described, play an important role in performing mathematical functions on the Oper-Ring 1. For that reason, as seen from the perspective of the front face 15 of the support handle 20, the left-side rod segments will be further identified with a negative sign (−), while the righat-side rod segments will be clarified by use of a positive sign (+).

Referring to FIG. 1 and beginning at the left side of the top surface 17 of the supporat handle 20, the rod segments are named left (−) support rod 5, left (−) apex 7, left (−) calculating rod 9, left (−) retaining bend 11, divider bend 12, right (+) retaining bend 10, right (+) operational rod 8, right (+) apex 6 and right (+) storage rod 4, which right (+) storage rod 4 completes a circuit by itself being anchored into the right side of the top surface 17 of the support handle 20. A permanently affixed left (−) support disc 3 is permanently affixed to the left (−) storage rod 5 just above the top surface 17 of the support handle 20. Likewise, a right (+) support disc 2 is affixed to the right (−) storage rod 4. Both support discs 2, 3 serve as a resting point for stacked light beads 14 and the stacked dark beads 13, respectively.

The right (+) retaining bend 10 and the left (−) retaining bend 11 serve to prevent further movement of any bottom-most light beads 14 or dark beads 13 during manipulations of said beads upon either the right (+) operational rod 8 or the left (−) operational rod 9.

As a teaching aide, the Oper-Ring 1 is a concept builder that may be used to visually explain mathematical operations. It is a hand-held abacus with two bent rods. Each rod, as shown in FIG. 1, is bent into two segments: a right storage rod 4 and right operational rod 8, and a left storage rod 5 and left operational rod 9. The two rods can be used to teach certain mathematical concepts at two student levels. Level I consists of the primary grades 1-5, while Level II includes topics at the middle and high school, grades 6-10. The inventive concept herein can be utilized for the following mathematical functions:
1. Count whole numbers
2. Add whole numbers
3. Practice number facts
4. Subtract whole numbers
5. Multiply whole numbers
6. Divide whole numbers
7. Demonstrate mathematics vocabulary
8. Demonstrate mathematics clue words for operations
9. Demonstrate the zero principle
10. Demonstrate the even-odd number theory
11. Demonstrate and practice theory of divisibility
12. Demonstrate remainder theory
13. Demonstrate and practice the order of operations
14. Demonstrate and practice the laws of integers
15. Demonstrate and practice the additive inverse theory
16. Demonstrate and practice the properties of real numbers
17. Demonstrate and practice expressions and solving equations.
Users, e.g. students, are referred to as “pulling” beads from either storage rod 4, 5 to place onto the corresponding operations rod 8, 9 as they perform various mathematical calculations. For illustrative purposes only, the following examples utilize an Oper-Ring 1 containing twenty beads on each storage rod 4, 5.

1. Counting Whole Numbers.

In referring to FIG. 1, a student can pull beads 13, 14, one-by-one, up either storage rod 4, 5 and over either apex 6, 7 onto the corresponding operational rod 8, 9 until a specified number may be completed. Counting to ten, the student can slide the beads over either storage rod 4, 5 until ten beads 13, 14 are on the respective operational rod 8, 9.

2. Adding Whole Numbers.

Beads from either storage rod of the same color, or from different colors, may be used to assist students in understanding the concept of counting, or adding whole numbers. The students start with all beads 13, 14 on either storage rod 4, 5. For example, to add seven plus three, pulling seven beads 13 from storage rod 5 over and onto operational rod 9, then repeating the same procedure with three beads 13 placed onto operational rod 9 will allow students to “see” the operation of counting as a relationship to adding two or more sets of counting numbers.

3. Practicing Number Facts.

A “number family” is defined as the various pairings of numbers, all of which will total a specified number. Beads for a number family can be pulled on either storage rod 4, 5. Students can “see” the relationship that, i.e., for the family of seven's, 1+6=7, 2+5=7, 3+4=7, by pulling certain beads 13, 14. For each of the number families, students can pull the sum of pairs of corresponding numbers and see the facts for each family, two through twenty, depending on how many beads 13, 14 are integrally placed on the storage rods 4, 5 of a particular Oper-Ring 1 device.

4. Subtracting Whole Numbers.

Beads from the same color on either storage rod 4, 5 or from different color beads 13 14 on the opposite storage rod 4, 5 may be used to assist students in understanding the concept of subtraction of whole numbers. The students start with all beads 13, 14 on the storage rod 4, 5. To subtract three from seven, pulling seven beads 13 from storage rod 5 onto the operational rod 9, and then pulling three beads 14 from storage rod 4 onto the operational rod 8, students can “see” the difference (number of beads) remaining. This difference is evident when the two parallel columns of beads 13, 14 are lined up on the two operational rods 8, 9. The students can check their visual answers by performing the opposite operation of addition. Simply add the difference in quantity of beads 13, 14 to the smaller number of beads, and the students will arrive at the larger number.

5. Multiplying Whole Numbers.

Beads 13, 14 of the same color from either storage rod 4, 5 or from different colors on both storage rods 4, 5 may be used to assist students in understanding the concept of multiplication of whole numbers. As an example, the students may start with all beads 14 on the storage rod 4. To multiply four times three, the students are directed to pull four sets of three beads 14 from the storage rod 4 onto the operational rod 8. At this point, the students can “see” the product when the pulled beads 14 are lined up on the operational rod 8. Four sets of three beads 14 will result in a “product” consisting of twelve beads 14. Now, holding the Oper-Ring 1 horizontally, the students can “check” their answer by pulling exactly twelve beads 13 of the other color from storage rod 5 onto operational rod 9. Thus, the students can see the one-to-one correspondence to the functions performed on one operational rod 8 and the count from the opposite operational rod 9.

6. Dividing Whole Numbers.

Beads of the same color from either storage rod 4, 5 or from different colors may be used to assist students in understanding the concept of division of whole numbers. Holding the Oper-Ring 1 horizontally, the students may start with all beads 13 on storage rod 5. To divide 20 by 4, for example, the students are advised that the calculation will involve compiling four sets of the correct number of beads 13. Therefore, by dividing the beads 13 into four sets of five beads 13 with no remaining beads 13 (remainder), the students can “see” the quotient is five beads 13 per set. The answer may be checked when the beads 13 are lined up and compared with the twenty beads 14 on the opposite storage rod 4. Four sets of five beads 13 each will result in the original twenty beads 13.

7. Demonstrating Mathematics Vocabulary.

Mathematics vocabulary words depicting the answer for the given operation such as (but not limited to) counting (add on to), adding (sum), subtracting (difference), multiplying (product), and dividing (quotient) are easily blended into a lesson on the Oper-Ring 1.

8. Demonstrating Mathematics Clues for Words of Operations.

Words associated with mathematical operations can be demonstrated using the storage and operational rods. For instance the words “sum,” “total,” and “in all” are associated with addition; “difference,” “less,” and “more” are related to subtraction; “product,” “twice,” and “times,” are associated with multiplication; while “quotient,” “per,” and “each” are frequently associated with division problems. These clue words can be demonstrated with the inventive concept. A basic example is a math addition problem phrased such that “Juan sold seven magazine subscriptions and Mary sold five subscriptions. How many subscriptions did the two students sell in all?” Using FIG. 1, a learner will start with the Oper Ring 1 in its starting configuration with both storage rods 5 and 4 loaded with their respective full complement of beads 13, 14. As the learner pulls seven beads 13 from storage rod 5 and five beads 14 from storage rod 4, it is easily discernable from both operational rods 9, 8, that, “in all” the “sum” of the magazine subscriptions equals twelve (beads).

9. Demonstrating the Zero Principle.

Any number when added to zero results in the given number. For instance, 1+0=1; 2+0=2; 3+0=3; 9+0=9; and 10+0=10. Conversely, when zero is added to any number, the sum is the given number. This principle is demonstrated, by way of illustration through FIG. 1, by placing all available beads 14 on a storage rod 4 and designating the corresponding operational rod 8 as a demonstration of zero quantity. By simply moving any number of the available beads 14 from the storage rod 4 to the operational rod 8 (zero), the resulting number of beads 14 will be equal to zero plus the number of beads 14 moved.

10. Demonstrating Even-Odd Number Theory.

Using both the storage rod 4 and the operational rod 8, the students can compare the remaining beads 14 when both rods 4, 8 contain beads. A number is even if the number of beads can be divided into equal sets without any beads remaining. If only one bead 14 remains after sets of 2's are made, the number of beads examined is odd. Students are directed to pull 8 beads 14 from the storage rod 4 onto the operational rod 8. Four separate sets of 2's can be made with no single bead 14 remaining. Therefore, the number 8 is an even number. Students are then directed to pull 9 beads 14 onto the storage rod 4, using sets of two beads 14 at a time. After positioning the beads 14 in sets of 2, it is seen that one bead 14 will be positioned alone, remaining un-paired. Therefore, the number 9 is an odd number.

11. Demonstrating and Practicing the Theory of Factors and Divisibility.

A first number is defined as a factor of a second number if the first number can be evenly divided into the second number with no remaining smaller number. This can be demonstrated to students by grouping (from a storage rod 4, 5 onto an operational rod 8, 9) a specified number of sets of beads 13, 14 which collectively total the amount of the second number. If there are no remaining beads on the corresponding storage rod 4, 5 then the first number is a factor of the second number.

Using the Oper-Ring 1 to test whether the number 7 is a factor of the number 20 or conversely, if the number 20 is easily divisible by 7, the students can begin by observing 20 beads 14 on the right storage rod 4. The students then pull as many sets of seven beads 14 as they can and place these individual sets onto the right operations rod 8. It is noted that only two sets of 7 beads 14 each can be pulled, leaving six beads 14 remaining on the storage rod 4. Therefore, the number 7 is not a factor of the number 20. Likewise, to see if the number 4 is a factor of 20, the twenty beads 14 on storage rod 4 are divided into sets of 4 beads 14. A total of five sets of four beads 14 are pulled and no beads 14 will remain on the storage rod 4. The number 4 is therefore a factor of the number 20.

12. Demonstrating Remainder Theory.

When a first number is divided by a second, smaller number and the result is not completely solved because of a number left behind that is even smaller than the second number, the “left-over” number is defined as the “remainder.”This can be further explained by thinking of the first number being divided by a specified number of sets of the smaller, second number. If there is an incomplete set left as a result, this incomplete set is termed the “remainder.” Using the Oper-Ring 1 horizontally, the students may begin by observing on storage rod 5 a total of twenty beads 13. If the problem is to divide the number 20 by the number 9, students can pull a set of nine beads 13 (the “divisor”) from the storage rod 5 and onto the operational rod 9. Of the remaining beads 13, they then pull a second set of nine beads 13 onto the operational rod 9. A total of two sets of nine beads 13 are assembled, and it is noted that two individual beads 13 remain on the storage rod 5; these two beads 13 are designated as the “remainder.”

13. Demonstrating and practicing the order of operations.

Each student will “see,” when using the Oper-Ring 1, that the order by which he/she adds or multiplies does not change the sum or product. This fact is not necessarily true for subtraction or division. Examples: 3+4=4+3, =7; and 3×4=4×3=12. This may be practiced by pulling three sets of four beads 14 from the storage rod 4 onto the operational rod 8, which the student can verify by counting a total of twelve beads 13 aligned on the operational rod 8. Conversely, students can pull four sets of three beads 13 from the storage rod 5 onto the operational rod 9. Then, the students can count the total number of beads 13 in the four sets and verify that the total is 12, which is the same total as on operational rod 8.

14. Demonstrating and Practicing the Law of Integers.

For this mathematical demonstration, the left storage rod 4 the Oper-Ring 1 contains a plurality of yellow beads, 14 and the right storage rod 5 contains a plurality of red beads 13. Using both storage rods 4, 5 of different colors and further, designating the yellow beads 14 as positive integers and the red beads 13 as negative integers, the student can “see” the sum, the difference, product, and quotient when operating with integers. When performing mathematical calculations with numbers having signs (+ or −) either the signs of the numbers will be alike or unlike. This is further emphasized by the color of the beads 13, 14, where yellow beads 14 indicate a positive (+) integer and red beads 13 indicate a negative (−) integer. Likewise, the opposite of the positive integers are negative integers; and the opposite of negative integers are positive integers.

One interesting point is that there is actually no subtraction in the calculation of integers. For instance, the process of subtraction is achieved by combining two other mathematics operations including multiplication and addition. To subtract three from eight, one might write the following: 8−3=5, or express it abstractly, eight plus a minus three [8+(−)3]. This principle can be demonstrated with Oper Ring 1 by utilizing the color of beads 14 as having positive characteristics and the color of beads 13 as having negative characteristics. In referring to FIG. 1, the learner may place eight positive beads 14 onto the storage rod 9, then placing three negative beads 13 onto the storage rod 9. It is thereupon visually seen that the number of “positive” beads 14 exceeds the number of “negative” beads 13 by five. This solution to the subtraction problem is also tangibly discernable to a learner.

Comprehensively, when using the Oper-Ring 1 to add integers it can be seen that, (a) if the signs (colors of the beads 13 or 14) are alike, the sum of the beads 13 or 14, will include the sign of those beads 13 or 14 being added; and (b) if the signs (colors of the beads 13 or 14) are unlike, the sum will contain the sign corresponding to the color (red or yellow) having the larger number of beads 13 or 14.

For multiplication of integers, it can be shown that, if the signs (colors) are alike, the product is positive; and if the signs (colors) are unlike, the product is negative.

15. Demonstrating and Practicing the Additive Inverse Theory.

The additive inverse of a number is the number which is the same distance from zero on the number line. For example, the additive inverse of 7 is −7; the additive inverse of 5 is −5. When a number is added to its additive inverse, the sum is zero. This can be demonstrated to the students by having them pull seven, exemplified by the color yellow (lighter beads 14 in FIG. 1) from the storage rod 4 to the operational rod 8. Then, the learner pulls seven, exemplified by the color red (darker beads 13 in FIG. 1) from their storage rod 5 to the operational rod 9. Adding the yellow beads 14 and the red beds 13 will result in zero because there will be a one-to-one correspondence (as shown by the horizontal equality of each stack of beads) of negative signs and positive signs and thus no excess beads of either sign (color) will remain with which to upset the balance of zero.

16. Demonstrating and Practicing the Properties of Real Numbers

The commutative property of addition and the communitive property of multiplication are oftentimes both overlooked in the calculations of mathematics. The order that one adds or subtracts does not change the answer, and this is always readily demonstrable as learners use the Oper Ring 1 device.

17. Demonstrating the Techniques of Simplifying Expressions and Solving Equations.

Mathematical expressions and equations such as, but not limited to, “more than,” “less than,” “increased by,” “twice,” and “times” can all be demonstrated using the Oper-Ring 1. In addition, the following concepts are also teachable using the inventive device herein: number facts (2-20), laws of signed numbers, additive identity, laws of divisibility, and remainder theory.

As for mechanical variations of the disclosed device, portions of each storage rod 4, 5 and each operational rod 8, 9 may be constructed with circumferential ridges of a dimension sufficient to slightly retard the ease of movement of the beads 13, 14. The ridges should be spaced along the length of all rods at a distance equivalent to a stack of five beads 13, 14. Further, there may be a multiple number, greater than two, of storage and operational rods.

While preferred embodiments of the present inventive concept have been shown and disclosed herein, it will be obvious to those persons skilled in the art that such embodiments are presented by way of example only, and not as a limitation to the scope of the inventive concept. Numerous variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

1. A device for enhancing the teaching and learning of math concepts, comprising
one continuous rod curvilinearly bent into four parallel, co-planar, straight segments, with a short, undulating segment connecting the second and third straight segments, whereupon the first segment and the fourth such segment are bent toward each other at a ninety degree angle respectively, after which an identical even-numbered sum of through-drilled beads inserted slidably onto said first and fourth segments, following which the ends of said first and fourth segments are permanently imbedded into a solid base structure.

2. A device for enhancing the teaching and learning of math concepts, comprising
a continuous, circular cross-sectioned rod having gradual 180-degree bends at three equally-spaced locations, thus forming four co-planar segments, with the first of said segments and the fourth of said segments then bent toward each other, ninety degrees respectively, so as to form an orthogonal orientation with the remaining second and third segments, and further, a short, undulating segment is then constructed between said second and third segments, whereupon said first and fourth segments are each supplied with an even-numbered quantity of cylindrical beads with through-holes of a diameter slightly larger than the diameter of said rod, said beads being inserted onto the first and fourth segments respectively, after which, the proximal and distal ends of said rod are permanently embedded into a solid base support handle.

3. A device as in claim 1 wherein two continuous rods are, by the same process, bent into two sets of four-segments each, collectively containing eight segments with the resulting proximal and distal end of each of the two rods imbedded into a solid base structure.

4. A device as in any one of claims 1, 2, or 3, wherein said first segment and fourth segments exhibits a plurality of equal-spaced circumferential ridges serving to retard the ease of movement of said beads.

5. A device as in any one of claims 1, 2, or 3, wherein said first segment and fourth segment of each continuous rod contain 20 beads each, respectively.

6. A device as any one of claims 1, 2, or 3, wherein said first segment of the continuous rod contains an even number of said beads of a first color, and the fourth segment of the continuous rod contains an identical even number of beads of a second color,

7. A method for enhancing the teaching of basic mathematics concepts and operations, comprising the steps of
a) constructing a device comprising two inverted U-shaped parallel rods the stems of which are connected by an undulated horizontal section, thereby forming four segments and further having an even number of through-drilled beads inserted onto, and moveable along the said segments;
b) demonstrating addition functions by the movement of a sum of a designated number of beads on the first and second segments, and the placement of a sum of a designated number of beads on the third and fourth segments, thereby visually and tactilely displaying the solution of the function;
c) demonstrating subtraction functions by the placement of a first designated number of beads on a sole segment, and afterwards removing a smaller quantity of beads from the first designated number, thereby visually and tactilely displaying the remainder, or result of the subtraction function as the remaining beads;
d) demonstrating multiplication functions by the movement of multiple sets of a quantity of a designated number of beads from the first segment onto the second segment, thereby visually and tactilely displaying the product of the function;
e) demonstrating division calculations by the placement of a number of beads representing the dividend on one segment, followed by sequential movement of sets of beads (each set containing a number of beads equivalent to the divisor) onto the adjacent segment, with the resulting discernment that the total number of sets of beads thereby removed equals the dividend; and
f) demonstrating other math concepts such as counting, zero principle, remainder theory, the order of operations, additive inverse theory and others by the appropriate placement of beads in appropriate patterns along the segments of the device.
